(19) United States
(12) Patent Application Publication
(10) Pub. No.: US 2024/0157912 A1
(43) Pub. Date: May 16, 2024

(54) PANE ARRANGEMENT WITH A HEATABLE SENSOR WINDOW

(71) Applicant: SAINT-GOBAIN GLASS FRANCE, COURBEVOIE (FR)

(72) Inventors: Markus KEWITZ, AACHEN (DE); Thomas GALLINELLI, LE CREUSOT (FR); Varun RAMESH KUMAR, AACHEN (DE)

(21) Appl. No.: 18/554,938

(22) PCT Filed: Apr. 8, 2022
(86) PCT No.: PCT/EP2022/059367

§ 371 Date: Oct. 11, 2023

(30) Foreign Application Priority Data
Apr. 12, 2021 (EP) 21167776.0

(51) Int. Cl. B60S 1/02; H05B 3/86

(52) U.S. Cl. CPC B60S 1/026; H05B 3/86

(57) ABSTRACT

A pane arrangement with a heatable sensor window includes a composite pane including an outer pane having an exterior-side surface and an interior-side surface and an inner pane having an exterior-side surface and an interior-side surface, which are joined to one another via at least one thermoplastic intermediate layer; an enclosure arranged on the interior-side surface of the inner pane and having an inner surface and an outer surface; a radiation receiver and/or a radiation source, which face(s) the composite pane within the enclosure such that a beam path of electromagnetic radiation passes through a sensor window of the composite pane; a first heating element; and a second heating element. The first heating element is arranged below the beam path on the outer surface or on the inner surface of the enclosure and the second heating element is arranged in a region of the composite pane surrounding the sensor window.

The invention relates to a pane arrangement with a heatable sensor window, a method for its production, and its use.

Many motor vehicles, airplanes, helicopters, and watercraft are equipped with various optical sensors. Examples of optical sensors are camera systems, such as video cameras, night vision cameras, residual light amplifiers, or passive infrared detectors, such as FLIR (forward looking infrared). The camera systems can use light in the ultraviolet (UV), visible (VIS), and infrared wavelength range (IR). Even under bad weather conditions, such as darkness and fog, objects, motor vehicles, and people can be precisely detected. In motor vehicles, these camera systems can be arranged behind the windshield in the passenger compartment. Thus, even in traffic, they offer the possibility of detecting hazardous situations and obstacles in a timely manner.

There are additional areas of application for optical sensors in electronic distance measurement (EDM), for example, using laser range finders. The distance to other motor vehicles can be determined. Such systems are widely used in the military sector but there are many possible applications in the civilian sector as well. With measurements of the distance from the preceding vehicle, it is possible to determine the necessary safe following distance and to significantly increase traffic safety.

Because of their sensitivity to weather conditions or aerodynamics around the vehicle, such sensors must, in all cases, be protected by appropriate panes. The sensor can either be installed inside a motor vehicle or outside as with thermal imaging cameras of helicopters. In the latter case, the sensor is installed outside on the helicopter in a pivotable housing. With both options, clean and condensation-free panes are absolutely essential to ensure optimal function of the optical sensors.

Condensation and icing hamper the functioning of the sensors since they significantly reduce the transmission of electromagnetic radiation. Whereas wiper systems can be used for water droplets and dirt particles, they are generally inadequate in the case of icing. In this case, systems that at least briefly heat the pane segment associated with the sensor or the light source when needed and thus enable uninterrupted use are essential.

In addition to the outer pane surface of the outer pane of a composite pane, the inner side of the inner pane must above all be kept free of condensation. So that no dirt and dust particles foul the sensor, the arrangement consisting of the sensor and the composite pane is generally encapsulated. If moisture penetrates into this encapsulated space, this moisture can, especially with cold outside temperatures, condense on the inner side of the inner pane and restrict transmission through the pane region.

EP 1 605 729 A2 discloses an electrically heatable pane with a camera window that is kept free of condensation and ice by a heating element. The heating element is laminated into the pane adjacent the camera window.

US 2017/0347405 A1 discloses a windshield heating device comprising a heating wire that heats a first part of a windshield of a vehicle, wherein the first part is arranged in front of a camera, a glass heating device that heats a second part of the windshield, wherein the second part encloses the first part, and a control unit that controls the power supply to the heating wire and the glass heating device.

U.S. Pat. No. 10,027,860 B2 describes an arrangement for an image acquisition device in a vehicle with an image acquisition device for recording image data. The arrangement comprises a carrier part that can be positioned in the vehicle with its front side on or in front of the inner side of a vehicle pane, holding means for holding the image acquisition device, wherein the holding means are coupled to the carrier part such that the optical recording axis of the image acquisition device is directed into a region in front of the front side of the carrier part, and a heating device implemented such that the heat radiation generated by it is emitted in the direction of the region in front of the front side of the carrier part.

An arrangement for heating a viewing window of an image acquisition unit, comprising at least one heating element, a baffle plate, the viewing window, the image acquisition unit, and an optically transparent heat conducting medium that is arranged between the at least one heating element and the viewing window is disclosed in DE 10 2014 006 924A1.

WO 2013/131700 A1 discloses a pane arrangement with a heatable baffle plate.

EP 3 237 255 B1 discloses an adapter for a windshield sensor comprising a housing and an electrical resistance heater supported by the housing, wherein the electrical resistance heater comprises a first section for attaching to the windshield and a second section for attaching to a wall of the housing, wherein the first and second section are formed from a single continuous sheet of flexible material.

DE 10 2009 004045 A1 discloses a pane with a heatable optically transparent pane segment, comprising an upper pane, a heatable optically transparent intermediate layer, and a lower pane. The heatable optically transparent intermediate layer comprises an upper adhesive film, a heating element, an electrically conductive connection to the heating element, and a lower adhesive film.

WO 2021/049479 A1 discloses a pane with a sensor holder attached to the inner side of the pane, wherein a first heating element is attached on the side of the base plate of the sensor holder facing away from the pane and a second heating element is enclosed between the surface of the sensor holder and the pane in the region in which the sensor holder is mounted on the pane.

US 2017/334366 A1 discloses a windshield with an adapter for a windshield sensor mounted on the inner side of the windshield, wherein a first heating element is attached below the beam path of the sensor on the side of the adapter facing away from the windshield and a second heating element is attached in a region enclosed by the adapter on the inner side of the windshield.

A pane with a heatable optically transparent sensor field, comprising at least one pane, at least one optically transparent sensor field on the surface of the pane, and at least one heatable film attached on the optically transparent sensor field is disclosed in US 2012/103960 A1.

JP 6 439471 B2 discloses a pane with a first heating element arranged in the pane and a second heating element arranged on the inner side of the pane.

The arrangement of heating wires in the region of the sensor window results in undesirable optical distortions and/or light diffraction phenomena.

The object of the invention consists in providing an improved pane arrangement having a heatable sensor window which makes it possible to heat the sensor window of a composite pane and to minimize optical distortions in the region of the sensor window.

The object of the present invention is accomplished by a pane arrangement with a heatable sensor window in accordance with the independent claim 1. Preferred embodiments emerge from the subclaims.

Further aspects of the invention include a method for producing the pane arrangement and the use of the pane arrangement.

The invention relates to a pane arrangement with a heatable sensor window, at least comprising a composite pane, an enclosure, a radiation receiver and/or a radiation source, a first heating element, and a second heating element.

The composite pane comprises an outer pane having an exterior-side surface and an interior-side surface and an inner pane having an exterior-side surface and an interior-side surface that are joined to one another via at least one thermoplastic intermediate layer.

The enclosure has an inner surface and an outer surface and is, according to the invention, arranged on the interior-side surface of the inner pane.

The radiation receiver and/or the radiation source is arranged within the enclosure and, according to the invention, faces the composite pane such that a beam path of electromagnetic radiation passes through a sensor window of the composite pane.

According to the invention, the first heating element is arranged below the beam path of the electromagnetic radiation on the outer surface or on the inner surface of the enclosure.

According to the invention, the second heating element is arranged in a region of the composite pane surrounding the sensor window.

The expression “a region of the composite pane surrounding the sensor window” refers to the region of the composite pane adjacent the sensor window that runs around it. “Adjacent the sensor window” refers to the region of the composite pane that is directly adjacent the region of the sensor window or is spaced a maximum of 5 cm, preferably a maximum of 3 cm, particularly preferably a maximum of 2 cm, most particularly preferably a maximum of 1 cm therefrom. The second heating element extends around the sensor window in a frame-like manner and completely surrounds it.

As described above, the radiation receiver and/or the radiation source is/are arranged within the enclosure and face(s) the composite pane such that a beam path of electromagnetic radiation passes through a sensor window of the composite pane. The term “sensor window” thus refers to the region of the composite pane through which a beam path of electromagnetic radiation passes. The sensor window must be transparent to the electromagnetic information or signals that are to be received by the radiation receiver or that are to be transmitted through the sensor window by the radiation source. The sensor window can be any part of the composite pane or an inserted pane segment that has high transmission for the corresponding optical and electromagnetic signals. In the context of the invention, the feature “transparent” refers to the transparency in the wavelength range relevant for the radiation receiver or the radiation source. For radiation receivers or radiation sources in the visible range and/or in the infrared range, the transmission for wavelengths from 200 nm to 2000 nm is preferably more than 60%, particularly preferably >70%, and in particular >90%. For radiation receivers or radiation sources in the infrared range, the transmission in the wavelength range from 800 nm to 1300 nm is preferably more than 60%, particularly preferably >70%, and in particular >90%. The sensor window preferably occupies less than 10%, particularly preferably less than 5% of the surface of the composite pane.

The surfaces of the glass panes are typically referred to as follows:

The exterior-side surface of the outer pane is referred to as side I. The interior-side surface of the outer pane is referred to as side II. The exterior-side surface of the inner pane is referred to as side III. The interior-side surface of the inner pane is referred to as side IV.

The interior-side surface II of the outer pane and the exterior-side surface III of the inner pane face one another and are joined to one another by means of the at least one thermoplastic intermediate layer.

That surface of the respective pane that faces the external surroundings of the vehicle in the installed position is referred to as the exterior-side surface. That surface of the respective pane that faces the interior of the vehicle in the installed position is referred to as the interior-side surface.

The first heating element and the second heating element can be connected to a voltage source via supply lines. The first heating element and the second heating element can be connected to the same voltage source or the first heating element can be connected to a first voltage source; and the second heating element, to a second voltage source.

In a particularly preferred embodiment, the first heating element and the second heating element can be controlled and/or adjusted independently of one another. By separate control and/or adjustment of the two heating elements, the heating output of the first heating element and the second heating element can be adapted to the respective requirements, as a result of which particularly efficient heating of the sensor window is possible.

For example, to de-ice the sensor window, the first heating element and the second heating can be activated simultaneously. However, to keep a de-iced sensor window free of condensation, activation of the first heating element is generally sufficient. Consequently, after de-icing, the second heating element can be switched off.

In particular, in the embodiment, in which the first heating element and the second heating element can be controlled and/or adjusted independently of one another, the pane arrangement can additionally have a temperature sensor and a control unit. Depending on the temperature of the composite pane determined by means of the temperature sensor, by means of the control unit, the first heating element and the second heating element can then be activated together or only the first heating element or only the second heating element can be activated. Depending on the temperature of the pane determined by means of the temperature sensor, the heating output of the first heating element and/or the second heating element can, for example, also be adjusted by means of the control unit.

In a preferred embodiment of the pane arrangement according to the invention, when viewed through the pane arrangement from the outside, the second heating element is arranged outside the region in which the enclosure is arranged.

In an alternative embodiment of the pane arrangement according to the invention, when viewed from the outside, the second heating element can be arranged in the region in which the enclosure is arranged, in particular in the region in which the enclosure is attached to the interior-side surface of the inner pane.

The radiation receiver is, for example, a camera or a photosensitive sensor that can detect infrared, visible, and/or ultraviolet electromagnetic radiation. The radiation receiver preferably includes cameras for visible light of wavelengths from 400 nm to 800 nm and/or infrared light of wavelengths from 800 nm to 1300 nm.

The radiation source is preferably at least one light-emitting diode or laser that can emit infrared, visible, and/or ultraviolet electromagnetic radiation.

The radiation receiver and the radiation source can, for example, also be implemented as a camera-LI DAR combination.

The first heating element is preferably implemented as a heating film.

The term “a heating film” means a flat film that can be heated. It can, for example, be a polymer film that is coated with an electrically heatable coating. It can also be a polymer film onto which conductor tracks made of a metallic material are applied. Preferably, the polymer film contains or consists of ethylene vinyl acetate (EVA), polyvinyl butyral (PVB), polyurethane (PU), polyethylene terephthalate (PET), polyethylene (PE), or polyesters or mixtures or copolymers or derivatives thereof. Particularly preferably, the polymer film contains polyethylene terephthalate (PET). Alternatively, the heating film can also be a film a made of an electrically conductive polymer. Preferably the heating film is a thin plastic layer onto which conductor tracks made of metallic material are applied.

The person skilled in the art knows which materials are suitable as heating film. For example, the electrically heatable coating can be an indium tin oxide (ITO) or coating, a coating containing silver or a silver-containing alloy, a coating containing gold, aluminum, or tungsten, a graphite-containing coating or graphene. Examples of conductive and, thus, heatable polymers include poly-3,4-ethylendioxythiophene (PEDOT) with polystyrene sulfonate (PSS) as a counterion, doped polyacetylene (PAC), and polyaniline (PAni).

The first heating element advantageously has a base area of 20 cm² to 300 cm², preferably of 20 cm² to 40 cm² for arrangements on a windshield and 100 cm² to 300 cm² for rear windows of vehicles. The base area is preferably trapezoidal, with the larger of the two parallel sides arranged directly adjacent the composite pane. The first heating element preferably has a thickness of less than 2 mm, particularly preferably a thickness of less than 1 mm. Optionally, an insulating layer, for example, an insulating foam, can additionally be arranged on the first heating element on that surface that faces in the direction of the inner environment.

In an advantageous embodiment of the invention, the heating output of the first heating element is selected such that the heating element has a temperature of 30° C. to 90° C., preferably 50° C. to 70° C. For this, typically, heating output of 0.5 W/dm² to 10 W/dm² is required. Such heating output is sufficient to free the inner side of the composite pane of condensation in the predefined range under the standard conditions of motor vehicle engineering by means of radiant heat.

In a preferred embodiment, the first heating element has heating output of 0.1 W/cm² to 1 W/cm² and/or the second heating element has line output of 5 W/m to 20 W/m. For example, the first heating element has heating output of 0.35 W/cm².

In one embodiment, the second heating element is implemented as at least one silver wire printed on the interior-side surface of the outer pane. Alternatively, the second heating element can also be implemented as at least one silver wire printed on the exterior-side surface of the inner pane. Alternatively, the second heating element can also be implemented as at least one silver wire printed on the interior-side surface of the inner pane. In another alternative embodiment, the second heating element is implemented as at least one silver wire printed on one of the surfaces of the at least one thermoplastic intermediate layer.

In a particularly preferred embodiment, the second heating element is arranged between the outer pane and the inner pane. In this embodiment, the heating element can thus be arranged between the outer pane and the at least one thermoplastic intermediate layer, between the inner pane and the at least one thermoplastic intermediate layer, or if the outer pane and the inner pane of the composite pane are joined to one another via at least two thermoplastic intermediate layers, also between two of the at least two thermoplastic intermediate layers.

In one embodiment, the second heating element is at least one silver wire printed on the interior-side surface of the outer pane, on the exterior-side surface of the inner pane, or on a surface of the at least one thermoplastic intermediate layer.

The second heating element can also be implemented as at least one copper or tungsten wire that is arranged between the at least one thermoplastic intermediate layer and the outer pane or between the at least one thermoplastic intermediate layer and the inner pane.

Alternatively, the second heating element can also be implemented as at least one heating film that is arranged between the at least one thermoplastic intermediate layer and the outer pane or between the at least one thermoplastic intermediate layer and the inner pane.

In embodiments, in which the outer pane and the inner pane of the composite pane are joined to one another via at least two thermoplastic intermediate layers, the second heating element can also be as at least one copper or tungsten wire arranged between two of the at least two thermoplastic intermediate layers or a heating film arranged between two of the at least two thermoplastic intermediate layers.

If the second heating element is implemented as a printed silver wire, it preferably has a maximum thickness of 300 μm (microns). The minimum thickness of the second heating element implemented as a printed silver wire is preferably 100 μm. If the second heating element is implemented as a copper or tungsten wire, it preferably has a maximum thickness of 150 μm. If the second heating element is implemented as a copper wire, it preferably has a thickness of at least 50 μm. If the second heating element is implemented as a tungsten wire, it preferably has a thickness of at least 35 μm.

In a preferred embodiment, the first heating element is arranged on the outer surface of the enclosure. Thus, in this embodiment, the first heating element is arranged outside the space enclosed by the enclosure and the composite pane.

However, it is also possible for the first heating element to be arranged on the inner surface of the enclosure. In this embodiment, the first heating element is implemented as a heatable baffle plate. Thus, in this embodiment, the first heating element is arranged within the space enclosed by the enclosure and the composite pane.

In an advantageous embodiment, a first heating element implemented as a baffle plate is patterned on the surface facing the composite pane and, in particular, on the side facing the beam path. The patterning is, for example, fluting or a zigzag or wave-shaped form. This has the particular advantage that, as much as possible, scattered light is not reflected into the radiation receiver.

As described above, the second heating element can be at least one printed silver wire or at least one copper or tungsten wire. In a preferred embodiment, the second heating element is implemented as at least two printed silver wires or at least two copper or tungsten wires. The at least two printed silver wires or the at least two copper or tungsten wires can, for example, form a grid-like structure that is arranged in a region surrounding the sensor window. Suitable structures and arrangements for the at least one printed silver wire or the at least one copper or tungsten wire are known to the person skilled in the art. For example, a single wire can also be arranged around the sensor window in a wave-shaped or meander-shaped manner.

The enclosure and the composite pane form an enclosed space in which the radiation receiver and/or the radiation source is arranged.

The enclosure protects the radiation receiver or the radiation source against dirt and dust particles as well as unwanted light incidence. The enclosure preferably contains a polymer, particularly preferably polybutylene terephthalate, polyamides, polycarbonate, polyurethanes, polybutylene, polypropylene, polyethylene, polyethylene terephthalate, polyvinyl chloride, polystyrene, acrylonitrile butadiene styrene, ethylene vinyl acetate, ethylene vinyl alcohol, polyimides, polyesters, polyketones, polyether ether ketones, and/or polymethyl methacrylate as well as mixtures, block polymers, and copolymers thereof.

The enclosure is advantageously bonded to the pane by an adhesive. The adhesive preferably contains acrylic adhesives, methyl methacrylate adhesives, cyanoacrylate adhesives, polyepoxides, silicone adhesives, and/or silane-cross-linking polymer adhesives as well as mixtures and/or copolymers thereof.

The enclosure is advantageously designed in multiple parts, with a support part bonded to the interior-side surface of the inner pane by an adhesive and a cover for service purposes detachably connected to the support part. However, the enclosure can also be designed as a single part.

The enclosure is preferably arranged in the upper region of the composite pane, for example, in the upper region of a windshield and/or rear window. Particularly preferably, the enclosure is arranged behind a masking strip, a sun visor, and/or a band filter. Preferably, the enclosure is not farther than 30% of the height of the composite pane from the upper edge or the lower edge of the composite pane.

The enclosure preferably contains water-absorbent materials or desiccants, particularly preferably silica gel, CaCl₂, Na₂SO₄, activated carbon, silicates, bentonites, zeolites, and/or mixtures thereof. The desiccants can be incorporated into the surface of the enclosure and/or arranged in open containers in the enclosure. The desiccants are preferably arranged such that an air and moisture exchange with the air in the interior of the enclosure is possible, but the materials are fixed and cannot fly around. This can preferably be accomplished by enclosing the desiccants in an air- and moisture-permeable polymer film or in a fine meshed net.

The interior-side surface of the outer pane and/or the exterior-side surface or the interior-side surface of the inner pane can include a masking print, in particular made of a dark, preferably black, enamel. The masking print is, in particular, a peripheral, i.e., frame-like, masking print. In the pane arrangement, the peripheral masking print serves primarily as UV protection for the mounting adhesive of the composite pane when the pane arrangement is mounted in a vehicle. The masking print can be opaque and cover the entire surface. The masking print can also be semi-transparent, at least in some sections, for example, as a dot grid, strip grid, or checkered grid. Alternatively, the masking print can also have a gradient, for example, from an opaque covering to a semi-transparent covering.

The masking print is preferably enlarged around the sensor window in the direction of the center of the pane such that the region in which the enclosure is glued to the interior-side surface of the inner pane is concealed when viewed from the outside.

In a preferred embodiment, the composite pane of the pane arrangement has a masking print in an edge region and in a region around the sensor window.

The at least one thermoplastic intermediate layer can contain or consist of at least polyvinyl butyral (PVB), ethylene vinyl acetate (EVA), polyurethane (PU), or mixtures or copolymers or derivatives thereof, preferably polyvinyl butyral (PVB). The thickness of the thermoplastic intermediate layer is preferably from 0.2 mm to 2 mm, particularly preferably from 0.3 mm to 1 mm, for example, 0.38 mm or 0.76 mm. If the vehicle composite pane includes two or more thermoplastic intermediate layers, the individual intermediate layers can also be made of different materials.

The at least one thermoplastic intermediate layer preferably has a constant thickness. However, the at least one thermoplastic intermediate layer can also have a wedge-shaped cross-section. The wedge angle of a wedge-shaped intermediate layer is preferably 0.1 mrad to 1.0 mrad, particularly preferably 0.15 mrad to 0.75 mrad, most particularly preferably 0.3 mrad to 0.7 mrad.

The at least one thermoplastic intermediate layer can also be a functional intermediate layer, in particular an intermediate layer with acoustically damping properties, an intermediate layer colored in at least some sections, and/or an intermediate layer tinted at least in some sections. For example, the at least one thermoplastic intermediate layer can also be, for example, a band filter film.

In one embodiment, the thermoplastic intermediate layer is a functional intermediate layer with acoustically damping properties. Such an acoustically damping intermediate layer typically consists of at least three plies, wherein the middle ply has higher plasticity or elasticity than the surrounding outer plies, for example, due to higher plasticizer content.

The outer pane and the inner pane are preferably made of glass, in particular soda lime glass, which is common for window panes. However, the panes can, in principle, also be made of other types of glass (for example, borosilicate glass, quartz glass, aluminosilicate glass) or transparent plastics (for example, polymethyl methacrylate or polycarbonate). The thickness of the panes can vary widely. Preferably, panes with a thickness in the range from 0.8 mm to 5 mm, preferably from 1.4 mm to 2.5 mm, for example, with the standard thicknesses 1.6 mm or 2.1 mm, are used. It is, however, also possible for the outer pane or, in particular, the inner pane to have a thickness of 0.55 mm or 0.7 mm. It is also possible for the outer pane and/or the inner pane to have a wedge-shaped cross-section.

The outer pane and the inner pane can be, independently of one another, clear and colorless, but also tinted, frosted, or colored. The total transmittance through the composite pane is, in a preferred embodiment, greater than 70%. The term “total transmittance” is based on the process for testing the light permeability of motor vehicle windows specified by ECE-R 43, Annex 3, § 9.1.

The outer pane and the inner pane can, independently of one another, be non-tempered, partially tempered, or tempered. If at least one of the panes is to be tempered, this can be thermal or chemical tempering.

The composite pane of the pane arrangement according to the invention is preferably curved in one or a plurality of spatial directions, as is customary for motor vehicle windows, with typical radii of curvature in the range from approx. 10 cm to approx. 40 m. The composite glass of the pane arrangement according to the invention can, however, also be flat, for example, when it is provided as a pane for buses, trains, or tractors.

The invention also includes a method for producing a pane arrangement according to the invention with a heatable sensor window.

The method according to the invention includes, as a first step, providing a composite pane and a second heating element, wherein the composite pane comprises an outer pane having an exterior-side surface and an interior-side surface and an inner pane having an exterior-side surface and an interior-side surface that are joined to one another via at least one thermoplastic intermediate layer and wherein the second heating element is arranged in a region of the composite pane surrounding a sensor window of the composite pane.

As a second step, the method according to the invention includes mounting an enclosure having an inner surface and an outer surface and a receiver and/or radiation source mounted within the enclosure on the interior-side surface of the inner pane, wherein a beam path of electromagnetic radiation of the radiation receiver and/or der radiation source runs through the sensor window of the composite pane and a first heating element is arranged below the beam path on the outer surface or on the inner surface of the enclosure.

The invention also relates to the use of a pane arrangement with a heatable sensor window according to the invention in vehicles, watercraft, airplanes and helicopters, preferably as a windshield or rear window of a motor vehicle.

The various embodiments of the invention can be implemented individually or in any combinations. In particular, the features mentioned above and to be explained below can be used not only in the combinations indicated but also in other combinations or in isolation without departing from the scope of the present invention.

In the following, the invention is explained in detail with reference to drawings and exemplary embodiments. The drawings are schematic representations and not to scale. The drawings in no way restrict the invention.

They depict:

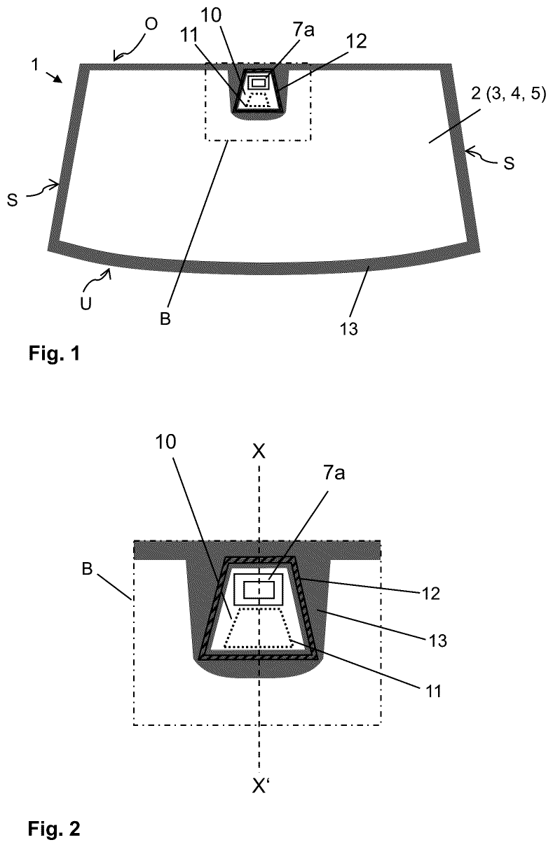

FIG. 1 a plan view of an embodiment of a pane arrangement according to the invention with a heatable sensor window,

FIG. 2 an enlarged view of the region B of FIG. 1,

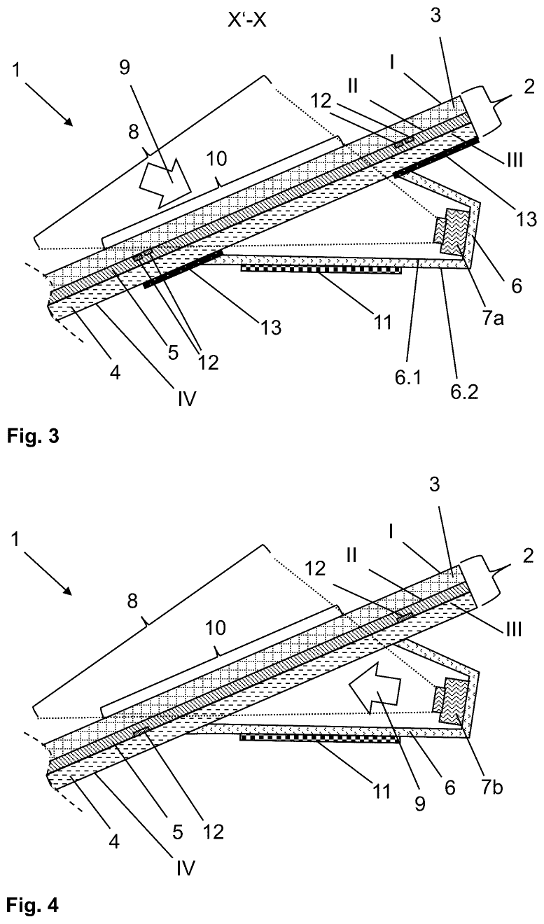

FIG. 3 a cross-section through the region B depicted in FIG. 2 of an embodiment of a pane arrangement according to the invention with a heatable sensor window along the section line X-X′,

FIG. 4 a cross-section of a detail of another embodiment of a pane arrangement according to the invention with a heatable sensor window,

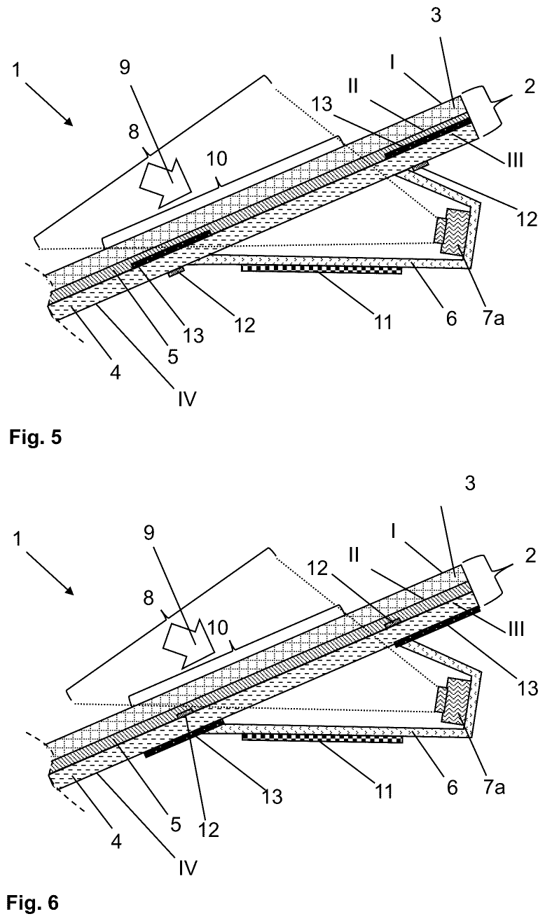

FIG. 5 a cross-section of a detail of another embodiment of a pane arrangement according to the invention with a heatable sensor window,

FIG. 6 a cross-section of a detail of another embodiment of a pane arrangement according to the invention with a heatable sensor window,

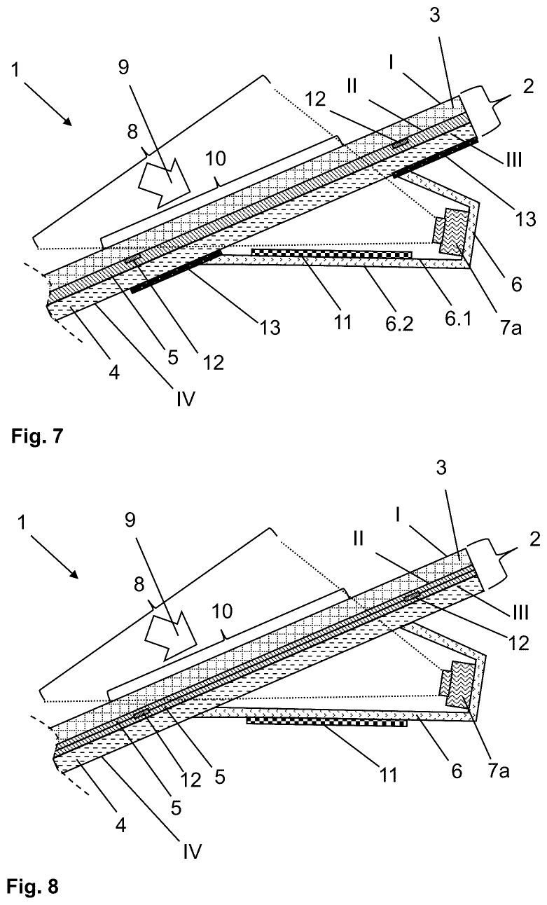

FIG. 7 a cross-section of a detail of another embodiment of a pane arrangement according to the invention with a heatable sensor window,

FIG. 8 a cross-section of a detail of another embodiment of a pane arrangement according to the invention with a heatable sensor window, and

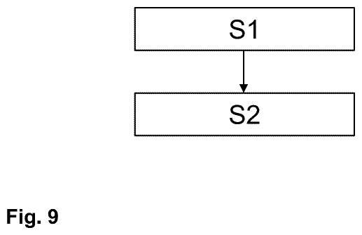

FIG. 9 a flow chart of a method according to the invention for producing a pane arrangement according to the invention with a heatable sensor window.

FIG. 1 depicts a plan view of an embodiment of a pane arrangement 1 according to the invention with a sensor window 10, and FIG. 2 depicts an enlarged view of the region B of FIG. 1. The pane arrangement 1 has, in the embodiment depicted in FIG. 1 and FIG. 2, a composite pane 2 comprising an outer pane 3 and an inner pane 4 that are joined to one another via at least one thermoplastic intermediate layer 5, an enclosure 6, a radiation receiver 7a, a sensor window 10, a first heating element 11, a second heating element 12, and a masking print 13. The composite pane 2 has an upper edge O, a lower edge U, and two side edges S extending therebetween. The masking print 13 is arranged at the edge and is enlarged around the sensor window 10 in the direction of the center of the composite pane 2. For better illustration, the enclosure 6, on whose inner surface 6.1 or outer surface 6.2 the first heating element 11 is arranged below the beam path of the radiation receiver 7a, is not shown in FIG. 1 and FIG. 2. As can be seen in FIGS. 1 and 2, the first heating element 11 is arranged below the beam path of the radiation receiver 7a, and the second heating element 12 is arranged in a region of the composite pane 2 surrounding the sensor window 10.

FIG. 3 depicts a cross-section through the region B depicted in FIG. 2 of an embodiment of a pane arrangement 1 according to the invention with a heatable sensor window 10 along the section line X-X′.

The pane arrangement 1 depicted as a detail in cross-section in FIG. 3 comprises a composite pane 2, an enclosure 6, a radiation receiver 7a, a first heating element 11, a second heating element 12, and a masking print 13. The composite pane 2 comprises an outer pane 3 having an exterior-side surface I and an interior-side surface II and an inner pane 4 having an exterior-side surface III and an interior-side surface IV, wherein the interior-side surface II of the outer pane 3 and the exterior-side surface III of the inner pane 4 are joined to one another via a thermoplastic intermediate layer 5.

The outer pane 3 is made, for example, of soda lime glass and is 2.1 mm thick. The inner pane 4 is made, for example, of soda lime glass and is 1.6 mm thick.

The thermoplastic intermediate layer 5 is made, in the embodiment depicted in FIG. 1, for example, of polyvinyl butyral (PVB) and is 0.76 mm thick.

The enclosure 6 having an inner surface 6.1 and an outer surface 6.2 is arranged on the interior-side surface IV of the inner pane 4 and is attached by gluing with an acrylate adhesive on the inner pane 4 of the composite pane 2. The composite pane 2 is, for example, a windshield of a motor vehicle. The enclosure contains, for example, polybutylene terephthalate with a 10% content of glass fibers (PBT-GF10) and was produced by an injection molding process.

A radiation receiver 7a is arranged within the enclosure 6 and below the composite pane 2. The radiation receiver 7a is, for example, an infrared camera for a night driving assistance system. The radiation receiver 7a detects, in particular, infrared electromagnetic radiation 9 in the wavelength range from 800 to 1100 nm. The field of vision of the radiation receiver 7a is oriented for image acquisition of the traffic space in front of the vehicle. The beam path 8 of the field of vision extends in the shape of a funnel from the exit lens of the radiation receiver 7a through the composite pane 2. The beam path 8 of the field of vision penetrates the composite pane 2 in the region of the sensor window 10. The sensor window 10 must be sufficiently transparent to the infrared electromagnetic radiation 9 of the radiation receiver 7a. The composite pane 2 has, in the region of the sensor window 10, for example, transparency for infrared radiation in the wavelength range from 800 nm to 1100 nm of more than 70%. The radiation receiver 7a is connected by supply lines (not shown) to evaluation electronics (not shown here).

In the embodiment depicted in FIG. 3, the first heating element 11 is arranged below the beam path 8 on the outer surface 6.2 of the enclosure 6. The first heating element 11 is in particular suitable for heating the enclosure in the region in which the first heating element 11 is arranged such that this region of the enclosure heats the sensor window 10 of the composite pane 2 by thermal radiation and frees it from condensation. The first heating element 11 is connected via supply lines (not shown here) to a voltage source, for example, to the onboard power supply of a motor vehicle.

The dimensions of the first heating element 11 are adapted to the dimensions of the enclosure 6 and the sensor window 10. The first heating element 11 is implemented as a heating film, i.e., for example, a film with an electrically conductive coating or conductor tracks made of a metallic material applied thereon.

In the embodiment depicted in FIG. 3, the second heating element 12 is arranged between the outer pane 3 and the thermoplastic intermediate layer 5 and, for example, is implemented as silver wires printed on the interior-side surface II of the outer pane and completely surrounding the sensor window 10. The printed silver wires are, for example, 200 μm thick. The second heating element 12 is in particular suitable for heating the sensor window 10 of the composite pane 2 by heat conduction, and, in combination the first heating element 11, for freeing the sensor window of ice. The second heating element 12 is connected via supply lines (not shown here) to a voltage source, for example, to the onboard power supply of a motor vehicle. In the embodiment depicted in FIG. 3, the second heating element 12, when viewed from the outside through the pane arrangement 1, is arranged outside the region in which the enclosure 6 is arranged.

In the embodiment depicted in FIG. 3, the composite pane 2 has, on the interior-side surface IV of the inner pane 4, a masking print 13 made of an opaque enamel that is arranged at the edge and is enlarged toward the center of the composite pane 2 in the region around the sensor window 10.

FIG. 4 depicts a cross-section of a detail of another embodiment of a pane arrangement 1 according to the invention with a heatable sensor window 10. The embodiment depicted as a detail in FIG. 4 differs from that depicted in FIG. 3 only in that, instead of a radiation receiver 7a, a radiation source 7b is arranged within the enclosure 6 and the composite pane 2 has no masking print 13. The radiation source 7b contains, for example, ten red light-emitting diodes and serves as a so-called third brake light on the rear window of a motor vehicle. The electromagnetic radiation 9 of the radiation source 7b penetrates the composite pane 2 in the region of the sensor window 10.

In the embodiment depicted in FIG. 4, the second heating element 12 is arranged between the inner pane 4 and the thermoplastic intermediate layer 5 in a region surrounding the sensor window 10 and implemented, for example, as a heating film with a thickness of 1 mm and a width of 1 cm. Preferably, the thickness of such a heating film is less than 2 cm, particularly preferably less than 1 cm and the width of the second heating element 12 implemented as a heating film is in the range from 0.5 cm to 2 cm.

In the embodiment depicted in FIG. 4, when viewed through the pane arrangement 1 from the outside, the second heating element 12 is arranged outside the region in which the enclosure 6 is arranged.

FIG. 5 depicts a cross-section of a detail of another embodiment of a pane arrangement 1 according to the invention with a heatable sensor window 10. The embodiment depicted as a detail in FIG. 5 differs from that depicted in FIG. 3 only in that the masking print 13 is arranged on the exterior-side surface III of the inner pane 4 and the second heating element 12 is implemented as a silver wire with a thickness of 300 μm printed on the interior-side surface IV of the inner pane 4.

FIG. 6 depicts a cross-section of a detail of another embodiment of a pane arrangement 1 according to the invention with a heatable sensor window 10. The embodiment depicted as a detail in der FIG. 6 differs from that depicted in FIG. 3 only in that the second heating element 12, when viewed from the outside through the pane arrangement 1, is arranged between the inner pane 4 and the thermoplastic intermediate layer in the region in which the enclosure 6 is attached to the composite pane 2. Thus, when viewed from the outside through the pane arrangement 1, the second heating element 12 is also arranged within the region in which the enclosure 6 is arranged. The second heating element 12 is implemented, for example, as a copper wire with a thickness of 150 μm pressed into the surface of the thermoplastic intermediate layer 5 facing the inner pane 4.

FIG. 7 depicts a cross-section of a detail of another embodiment of a pane arrangement 1 according to the invention with a heatable sensor window 10. The embodiment depicted as a detail in FIG. 7 differs from that depicted in FIG. 3 only in that the first heating element 11 is arranged on the inner surface 6.1 of the enclosure 6 and is implemented as a heatable baffle plate. The first heating element 11 is thus suitable for heating the sensor window 10 by thermal radiation and freeing it of condensation.

FIG. 8 depicts a cross-section of a detail of another embodiment of a pane arrangement 1 according to the invention with a heatable sensor window 10. The embodiment depicted as a detail in FIG. 8 differs from that depicted in FIG. 3 only in that the composite pane 2 has two thermoplastic intermediate layers 5, via which the outer pane 3 and the inner pane 4 are joined to one another and the second heating element 12 is arranged between the two thermoplastic intermediate layers and is implemented, for example, as a tungsten wire with a thickness of 150 μm. The two thermoplastic intermediate layers 5 have, for example, in each case, a thickness of 0.38 mm and contain PVB. In addition, the composite pane 2 in the embodiment depicted in FIG. 8 has no masking print 13.

In the embodiment depicted in FIG. 8, when viewed through the pane arrangement 1 from the outside, the second heating element 12 is arranged outside the region in which the enclosure 6 is arranged.

FIG. 9 depicts a flow chart of a method according to the invention for producing a pane arrangement 1 according to the invention with a heatable sensor window 10.

In a first step S1, a composite pane 2, comprising an outer pane 3 having an exterior-side surface I and an interior-side surface II and an inner pane 4 having an exterior-side surface III and an interior-side surface IV, joined to one another via at least one thermoplastic intermediate layer 5, and a second heating element 12 are provided, with the second heating 25 element 12 arranged in a region of the composite pane 2 surrounding a sensor window 10 of the composite pane 2.

In a second step S2, an enclosure 6 having an inner surface 6.1 and an outer surface 6.2 and a radiation receiver 7a and/or radiation source 7b mounted within the enclosure 6 is mounted on the interior-side surface IV of the inner pane 4, wherein a beam path 8 of electromagnetic radiation 9 of the radiation receiver 7a and/or the radiation source 7b runs through the sensor window 10 of the composite pane 2 and a first heating element 11 is arranged below the beam path 8 on the outer surface 6.2 or on the inner surface 6.1 of the enclosure 6.

Using the pane arrangement according to the invention with a heatable sensor window, a sensor window with a size of 0.1 m² and an initial temperature of −18° C. can be de-iced in 7 minutes and 45 seconds using 175 mL/m² of water.

The de-icing performance of the pane arrangement according to the invention is thus comparable to that of pane arrangements with heating wires arranged within the sensor window, but offers optical advantages since no heating wires are arranged in the region of the sensor window and thus optical distortions or light diffraction phenomena caused by the heating wires are avoided.

### LIST OF REFERENCE CHARACTERS

1 pane arrangement
2 composite pane
3 outer pane
4 inner pane
5 thermoplastic intermediate layer
6 enclosure
6.1 inner surface of the enclosure
6.2 outer surface of the enclosure
7a radiation receiver
7b radiation source
8 beam path
9 electromagnetic radiation
10 sensor window
11 first heating element
12 second heating element
13 masking print
I exterior-side surface of the outer pane
II interior-side surface of the outer pane
III exterior-side surface of the inner pane
IV interior-side surface of the inner pane
O upper edge
U lower edge
S side edge
B region
X-X′ section line

1. A pane arrangement with a heatable sensor window, comprising:
a composite pane comprising an outer pane having an exterior-side surface and an interior-side surface and an inner pane having an exterior-side surface and an interior-side surface, which are joined to one another via at least one thermoplastic intermediate layer;
an enclosure arranged on the interior-side surface of the inner pane and having an inner surface and an outer surface;
a radiation receiver and/or a radiation source, which face(s) the composite pane within the enclosure such that a beam path of electromagnetic radiation passes through a sensor window of the composite pane;
a first heating element, and
a second heating element,
wherein the first heating element is arranged below the beam path on the outer surface or on the inner surface of the enclosure,
and the second heating element is arranged in a region of the composite pane surrounding the sensor window.

2. The pane arrangement according to claim 1, wherein the first heating element and the second heating element are controllable and/or adjustable independently of one another.

3. The pane arrangement according to claim 1, wherein, when viewed through the pane arrangement from the outside, the second heating element is arranged outside the region in which the enclosure is arranged.

4. The pane arrangement according to claim 1, wherein the radiation receiver contains a camera or a sensor for infrared, visible, and/or ultraviolet electromagnetic radiation or the radiation source contains at least one light-emitting diode or one laser for infrared, visible, and/or ultraviolet electromagnetic radiation.

5. The pane arrangement according to claim 1, wherein the first heating element is a heating film.

6. The pane arrangement according to claim 1, wherein the second heating element is arranged between the outer pane and the inner pane.

7. The pane arrangement according to claim 1, wherein the second heating element is at least one silver wire printed on the interior-side surface of the outer pane, on the exterior-side surface of the inner pane, or on a surface of the at least one thermoplastic intermediate layer.

8. The pane arrangement according to claim 1, wherein the second heating element is at least one copper or tungsten wire arranged between the at least one thermoplastic intermediate layer and the outer pane or between the at least one thermoplastic intermediate layer and the inner pane or a heating film arranged between the at least one thermoplastic intermediate layer and the outer pane or between the at least one thermoplastic intermediate layer and the inner pane.

9. The pane arrangement according to claim 1, wherein the outer pane and the inner pane are joined to one another via at least two thermoplastic intermediate layers and the second heating element is at least one copper or tungsten wire arranged between two of the at least two thermoplastic intermediate layers or is a heating film arranged between two of the at least two thermoplastic intermediate layers.

10. The pane arrangement according to claim 1, wherein the first heating element is arranged on the inner surface of the enclosure and is implemented as a heatable baffle plate or the first heating element is arranged on the outer surface of the enclosure.

11. The pane arrangement according to claim 1, further comprising a temperature sensor for determining the temperature of the composite pane and a control unit for controlling and/or adjusting the first heating element and/or the second heating element.

12. The pane arrangement according to claim 1, wherein the first heating element has a heating output of 0.1 W/cm² to 1 W/cm² and/or the second heating element has line output of 5 W/m to 20 W/m.

13. The pane arrangement according to claim 1, wherein the composite pane has a masking print in an edge region and in a region around the sensor window.

14. A method for producing a pane arrangement with a heatable sensor window according to claim 1, the method comprising:
a) providing a composite pane, comprising an outer pane having an exterior-side surface and an interior-side surface and an inner pane having an exterior-side surface and an interior-side surface, which are joined to one another via at least one thermoplastic intermediate layer,
and a second heating element,
wherein the second heating element is arranged in a region of the composite pane surrounding a sensor window of the composite pane;
b) mounting an enclosure having an inner surface and an outer surface and a radiation receiver and/or a radiation source mounted within the enclosure on the interior-side surface of the inner pane, wherein a beam path of electromagnetic radiation of the radiation receiver and/or the radiation source runs through the sensor window of the composite pane and a first heating element is arranged below the beam path on the outer surface or on the inner surface of the enclosure.

15. Use of A method comprising providing a pane arrangement with a heatable sensor window according to claim 1 in a vehicle, watercraft, airplane, or a helicopter.

16. The method according to claim 16, wherein the heatable sensor window is a windshield or rear window of a motor vehicle.
